(19) United States
(12) Patent Application Publication
(10) Pub. No.: US 2010/0229573 A1
(43) Pub. Date: Sep. 16, 2010

(54) FLOATING LNG STORAGE AND RE-GASIFICATION UNIT AND METHOD FOR RE-GASIFICATION OF LNG ON SAID UNIT

(76) Inventor: Markus Ehrström, Helsinki (FI)

Correspondence Address: Muncy, Geissler, Olds & Lowe, PLLC, 4000 Legato Road, Suite 310, FAIRFAX, VA, 22033, US

(21) Appl. No.: 12/679,435

(22) PCT Filed: Nov. 14, 2008
(86) PCT No.: PCT/FI2008/050661

§ 371 Date: Mar. 22, 2010

(30) Foreign Application Priority Data
Nov. 30, 2007 (FI) 20075857

(51) Int. Cl. F17C 9/02; F17C 13/08; F17C 1/00

(52) U.S. Cl. 62/50.2; 62/53.2; 62/53.1

(57) ABSTRACT

A floating LNG storage and re-gasification unit, which comprises a LNG storage tank (2), a power plant (3), and a vaporizing unit (5), which power plant is arranged to generate heat for the vaporizing unit. The power plant (3) comprises a number of heat sources, which are connected to a single heating circuit (4). In order to increase the overall efficiency of said unit, the single heating circuit is directly or indirectly connected to the vaporizing unit (5).

### TECHNICAL FIELD

The present invention relates to a floating LNG storage and re-gasification unit, which comprises a LNG storage tank, a power plant, and a vaporizing unit, which power plant is arranged to provide heat for the vaporizing unit according to the preamble of claim 1. The present invention also relates to a method for re-gasification of LNG on said unit according to the preamble of claim 9.

### BACKGROUND ART

The floating LNG (Liquefied Natural Gas) storage and re-gasification unit (FSRU) is a permanently moored LNG import terminal. FSRUs are therefore typically not provided with propulsion arrangements. So-called LNG carriers are used for transporting and supplying LNG to the FSRUs for storage. On board the FSRU, the LNG is pumped to a re-gasification unit, from which vaporized natural gas (NG) can be transferred, usually in underwater pipes, to shore and to end consumers. FSRUs are usually equipped with an onboard power plant for providing power for re-gasification equipment and hotel consumers.

There are two main LNG vaporization techniques. In so-called submerged combustion vaporizers (SCV) a gas burning water bath is used as a heating media. In so-called open rack vaporizers (ORV) LNG is led through a sea water heat exchanger, whereby sea water is used as a heating media. The known techniques consume a large amount of energy and generate additional undesired emissions.

### SUMMARY OF THE INVENTION

An object of the present invention is to avoid the drawbacks of the prior art and to provide an energy efficient floating LNG storage and re-gasification unit. This object is attained by a FSRU according to claim 1.

The basic idea of the present invention is to manage the overall efficiency of the LNG re-gasification unit. The onboard power plant comprises a number of heat sources, which are connected to a single heating circuit, whereby the heat recovered from these sources is collected into the single heating circuit, in which a first heating medium is circulated. The single heating circuit is directly or indirectly connected to the vaporizing unit. Basically all recoverably heat is thus collected and conducted directly or indirectly to the vaporizing unit providing a high degree of re-utilisation of heat.

The power plant is advantageously an internal combustion engine, whereby the heat sources comprise an engine high temperature cooling water circuit, an engine low temperature cooling water circuit, a lubricating oil circuit, an engine jacket water circuit, and an exhaust gas heat exchanger. Even though these represent different grades of recoverable heat, they are effective for the intended heating purpose, taking into account the usual storage temperature of LNG, which is about −162° C.

The internal combustion engine is advantageously a gas engine or dual fuel engine in order to facilitate fuel supply.

The single heating circuit is advantageously directly connected to the vaporizing unit, whereby the single heating circuit is led from the power plant directly to the vaporizing unit and from the vaporizing unit back to the power plant. This maximises the re-utilisation of the recovered heat circulated by the first heating medium in the single heating circuit.

In this connection, it is advantageous to employ a submerged combustion vaporizing unit (SCV) as a vaporizing unit. In such a configuration a main source of heat for the vaporizing unit, i.e. the vaporisation process, is provided by a natural gas burner which heats the water bath of the SCV. The single heating circuit discussed above is then used as a supplementary source of heat for the vaporization process. The seawater bed of the SCV is thus provided by additional heat from the first heating medium circulated in the single heating circuit, which results in lower gas consumption for the natural gas burner, and therefore less emissions and cost savings.

The single heating circuit is advantageously provided with an auxiliary heat exchanger arranged between the vaporizing unit and the power plant, whereby a sea water circuit is connected to the auxiliary heat exchanger. This provides an efficient back-up cooling arrangement for the power plant when the re-gasification equipment is not employed.

According to another advantageous embodiment of the invention, the single heating circuit is indirectly connected to the vaporizing unit, whereby the single heating circuit is led from the power plant directly to an auxiliary heat exchanger, which is directly connected to the vaporizing unit, and from the auxiliary heat exchanger back to the power plant. In this way a normally available heating medium, e.g. sea water thus used as a second heating medium, can efficiently be provided with supplementary heat from the first heating medium circulated in the single heating circuit to make the vaporization process more energy efficient.

In this connection, it is advantageous to employ an open rack vaporizing unit (ORV) as the vaporizing unit. In such a configuration a main source of heat for the vaporizing unit, i.e. the vaporisation process, is provided by a sea water circuit, in which sea water is circulated as a second heating medium through the ORV. The single heating circuit discussed above is then used as a supplementary source of heat for the vaporisation process. The sea water circuit of the ORV is thus provided by additional heat from the single heating circuit, which results in lower sea water pumping power consumption, and therefore less emissions and cost savings.

According to the method of the present invention, LNG is stored in a LNG storage tank, from which LNG is transferred to a vaporizing unit, whereby a power plant on the floating storage and re-gasification unit is operated for generating heat for the vaporising unit. The main and advantageous features of the method are defined in claims 9-16.

### BRIEF DESCRIPTION OF DRAWINGS

In the following the present invention will be described, by way of example only, in more detail with reference to the accompanying schematic drawings, in which

FIG. 1 illustrates a first embodiment of the present invention,

FIG. 2 illustrates a second embodiment of the present invention, and

FIG. 3 illustrates a third embodiment of the present invention.

### DETAILED DESCRIPTION

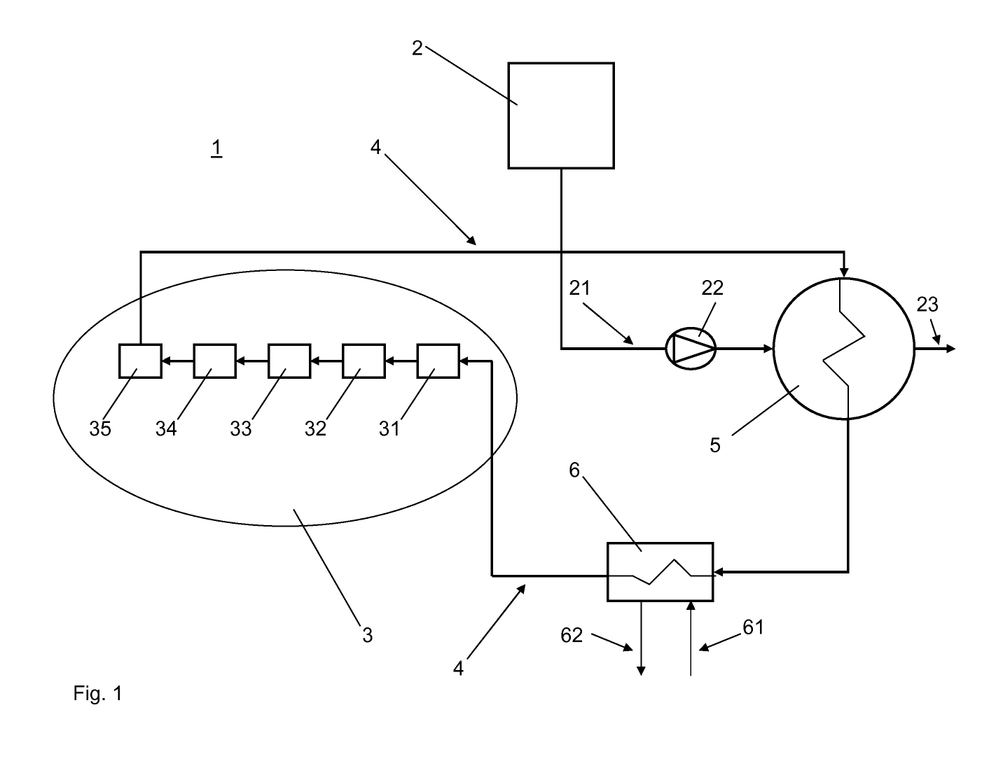

In FIG. 1 the floating LNG storage and re-gasification unit (FSRU) is generally indicated by reference numeral 1. The FSRU is a normally a permanently moored terminal, in the form of a marine vessel without propulsion means. The FSRU is provided with power production facilities, in this embodiment shown as a power plant indicated by reference numeral 3, re-gasification equipment and hotel consumers, as well as with LNG storage and LNG vaporization facilities. The FSRU is normally also provided with gas feeding means (not shown) for connection to appropriate pipelines in order to transfer the vaporized LNG to shore and to end consumers.

The FSRU comprises a LNG storage tank 2, which is connected to a vaporizing unit 5 through a feeding line 21 provided with a high pressure pump 22. The vaporizing unit 5, which is arranged as a heat exchanger, receives LNG from the LNG storage tank in liquefied form and discharges it after heating as natural gas through discharge line 23.

The power plant 3 is arranged to generate heat for the vaporizing unit. Heat for the vaporizing unit 5 is provided through a single heating circuit 4, in which a first heating medium is circulated and which forms a single loop directly connected to the vaporizing unit 5. This single heating circuit 4 is directed through the power plant 3 for collecting heat from all available heat sources of the power plant 3 and led directly to the vaporizing unit 5 in order to deliver said heat to the vaporizing unit 5 by means of the first heating medium for the vaporisation of the LNG.

In this embodiment the power plant 3 is a gas fuelled internal combustion engine, whereby the heat sources comprise an engine high temperature (HT) cooling water circuit 31, an engine low temperature (LT) cooling circuit 32, a lubricating oil circuit 33, an engine jacket water circuit 34, and an exhaust gas heat exchanger 35 (an exhaust gas boiler), which are only schematically indicated in the drawing.

Consequently, according to the present invention, all recoverable heat, or waste heat, from the power plant 3 is collected and directed into the single heating circuit 4 and then utilized directly in the vaporizing unit 5 by means of the first heating medium. This ensures a very high degree of overall energy efficiency with low investment costs on the FSRU.

According to the invention the FSRU is further provided with an auxiliary heat exchanger 6 directly connected to the single heating circuit 4. The auxiliary heat exchanger 6 is provided with a sea water circuit 61,62, where reference numeral 61 indicates the inflow of sea water and reference numeral 62 indicates the outflow of sea water. This auxiliary heat exchanger may function as a back-up cooler for the power plant 3 when the re-gasification equipment is not in use.

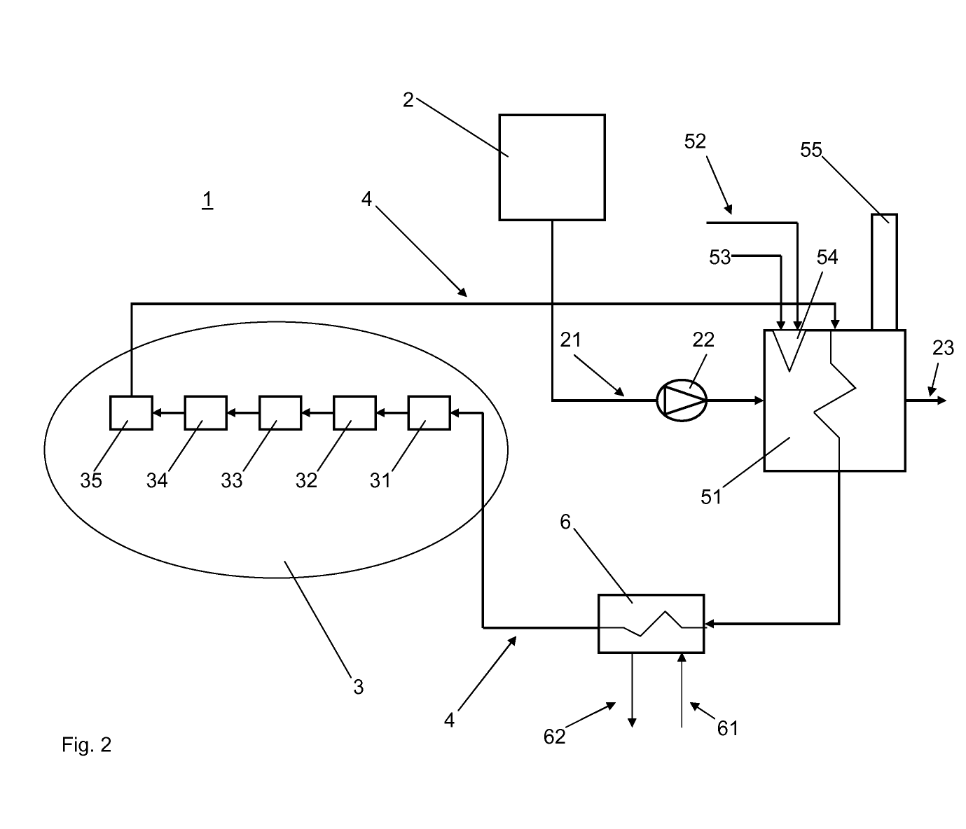

FIG. 2 illustrates a second embodiment of the invention in connection with a submerged combustion vaporizing unit (SCV).

As in connection with FIG. 1, the floating LNG storage and re-gasification unit (FSRU) is generally indicated by reference numeral 1. The FSRU is a normally a permanently moored terminal, in the form of a marine vessel without propulsion means. The FSRU is provided with power production facilities, in this embodiment shown as a power plant indicated by reference numeral 3, for re-gasification equipment and hotel consumers, as well as with LNG storage and LNG vaporization facilities. The FSRU is normally also provided with gas feeding means (not shown) for connection to appropriate pipe-lines in order to trans-fer the vaporized LNG to shore and to end consumers.

The FSRU comprises a LNG storage tank 2, which is connected to a vaporizing unit 51 through a feeding line 21 provided with a high pressure pump 22. The vaporizing unit 51, which is arranged as a heat exchanger, receives LNG from the LNG storage tank in liquefied form and discharges it after heating as natural gas through discharge line 23. The power plant 3 is arranged to generate heat for the vaporizing unit.

In this embodiment, the vaporizing unit 51 represents a so-called submerged combustion vaporizing unit (SCV). The vaporizing unit 51 basically forms a water bath which is heated by means of a natural gas burner 54 which is fuelled by natural gas, as indicated by fuel feed line 52, supplemented by combustion air, as indicated by air supply line 53. The exhaust gas discharge is indicated by reference numeral 55. In this configuration the heat provided by the natural gas burner 54 provides a main source of heat for the vaporization process. The natural gas for the natural gas burner 54 is naturally available from the LNG stored aboard the FSRU.

In addition to this main source of heat, heat for the vaporization process is also provided through a single heating circuit 4, in which a first heating medium is circulated and which forms a single loop directly connected to the vaporizing unit 51. This single heating circuit 4 is directed through the power plant 3 for collecting heat from all available heat sources of the power plant 3. The single heating circuit 4 is then led directly through the water bath of the vaporizing unit 51 in order to deliver said heat as a supplementary source of heat for the vaporizing unit 51 by raising the temperature of the water bath in the vaporizing unit 51 by means of heat provided by the first heating medium. Consequently, less heat needs to be provided by the natural gas burner 54.

In this embodiment the power plant 3 is a gas fuelled internal combustion engine, whereby the heat sources comprise an engine high temperature (HT) cooling water circuit 31, an engine low temperature (LT) cooling circuit 32, a lubricating oil circuit 33, an engine jacket water circuit 34, and an exhaust gas heat exchanger 35 (an exhaust gas boiler), which are only schematically indicated the drawing.

Consequently, according to the present invention, all recoverable heat, or waste heat, from the power plant 3 is collected and directed into the single heating circuit 4 and then utilized directly in the vaporizing unit 51 by means of the first heating medium. This ensures a very high degree of overall energy efficiency with low investment costs on the FSRU.

In connection with the above discussed submerged combustion vaporizing unit (SCV) the benefits can especially be seen in lower gas consumption, due to the additional waste heat supply from the power plant. This results in lower emissions and cost savings.

According to the invention the FSRU is further provided with an auxiliary heat exchanger 6 directly connected to the single heating circuit 4. The auxiliary heat exchanger 6 is provided with a sea water circuit 61,62, where reference numeral 61 indicates the inflow of sea water and reference numeral 62 indicates the outflow of sea water. This auxiliary heat exchanger may function as a back-up cooler for the power plant 3 when the re-gasification equipment is not in use.

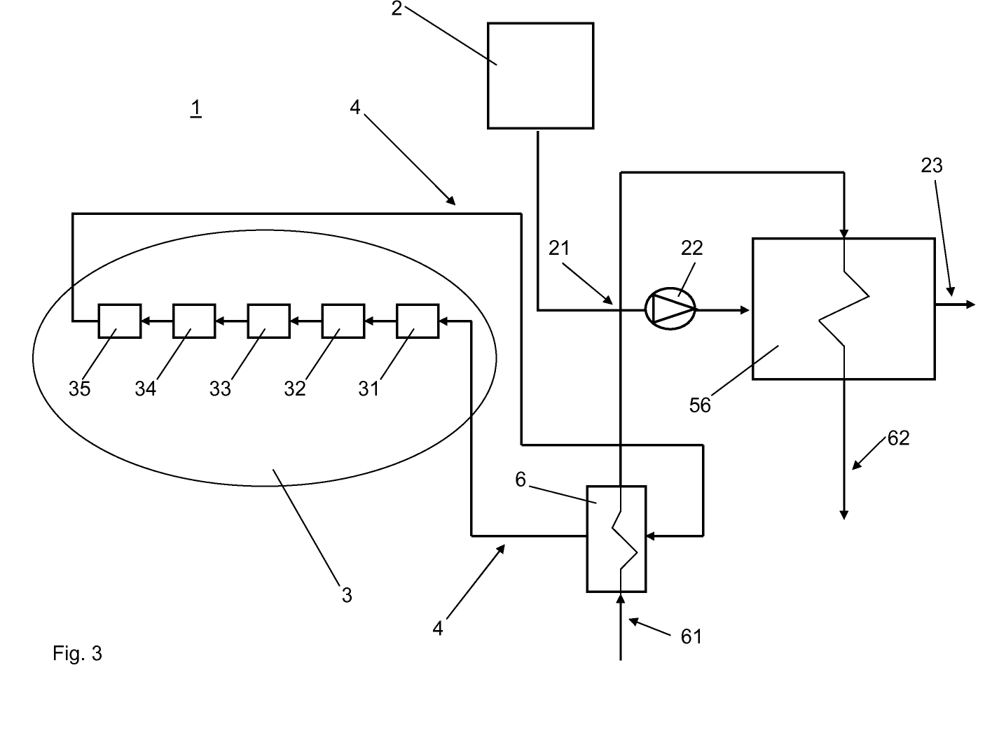

FIG. 3 illustrates a third embodiment of the invention in connection with an open rack vaporizing unit (ORV).

As in connection with FIG. 1, the floating LNG storage and re-gasification unit (FSRU) is generally indicated by reference numeral 1. The FSRU is a normally a permanently moored terminal, in the form of a marine vessel without propulsion means. The FSRU is provided with power production facilities, in this embodiment shown as a power plant indicated by reference numeral 3, for re-gasification equipment and hotel consumers, as well as with LNG storage and LNG vaporization facilities. The FSRU is normally also provided with gas feeding means (not shown) for connection to appropriate pipelines in order to transfer the vaporized LNG to shore and to end consumers.

The FSRU comprises a LNG storage tank 2, which is connected to a vaporizing unit 56 through a feeding line 21 provided with a high pressure pump 22. The vaporizing unit 56, which is arranged as a heat exchanger, receives LNG from the LNG storage tank in liquefied form and discharges it after heating as natural gas through discharge line 23. The power plant 3 is arranged to generate heat for the vaporizing unit.

In this embodiment, the vaporizing unit 56 represents a so-called open rack vaporizing unit (ORV), whereby the vaporizing unit 56 is connected to a sea water circuit 61,62, where reference numeral 61 indicates the inflow of sea water and reference numeral 62 the outflow of sea water. Sea water, which thus forms a second heating medium, is led through an auxiliary heat exchanger 6 and further to the vaporizing unit 56 and provides a main source of heat for the vaporizing unit 56.

In addition to this main source of heat, heat for the vaporization process is also provided through a single heating circuit 4, in which a first heating medium is circulated and which forms a single loop directly connected to the auxiliary heat exchanger 6, through which the sea water circuit 61,62 of the vaporizing unit 56 is led. This single heating circuit 4 is directed through the power plant 3 for collecting heat from all available heat sources of the power plant 3 and led directly to the auxiliary heat exchanger 6 in order to heat the sea water in the sea water circuit 61,62 before it is led through the vaporizing unit 56. The single heating circuit 4 thus functions as a supplementary source of heat for the vaporizing unit 56 by raising the temperature of the second heating medium, i.e. the sea water circulating through the vaporizing unit 56, by means of the first heating medium, which is circulated in the single heating circuit 4.

In this embodiment the power plant 3 is a gas fuelled internal combustion engine, whereby the heat sources comprise an engine high temperature (HT) cooling water circuit 31, an engine low temperature (LT) cooling circuit 32, a lubricating oil circuit 33, an engine jacket water circuit 34, and an exhaust gas heat exchanger 35 (an exhaust gas boiler), which are only schematically indicated in the drawing.

Consequently, according to the present invention, all recoverable heat, or waste heat, from the power plant 3 is collected and directed into the single heating circuit 4 and then utilized for providing additional heat for the vaporizing unit 56 by means of a heat exchange between the first heating medium and the second heating medium. This ensures a very high degree of overall energy efficiency with low investment costs on the FSRU.

In connection with the above mentioned open rack vaporizing units (ORV) the benefits can especially be seen in lower sea water pumping power consumption, due to the waste heat supply from the power plant. This results in lower emissions and cost savings.

According to the invention, the auxiliary heat exchanger 6, which is connected to the single heating circuit 4, may function as a back-up cooler for the power plant 3 when the re-gasification equipment is not in use as in connection with the embodiment according to FIG. 1.

The description and the thereto related drawings are intended to clarify the basic idea of the invention. The invention may vary in detail within the scope of the ensuing claims.

1. Floating LNG storage and re-gasification unit, which comprises a LNG storage tank (2), a power plant (3), and a vaporizing unit (5;51;56), which power plant is arranged to generate heat for the vaporizing unit, characterised in that the power plant (3) comprises a number of heat sources, that the heat sources are connected to a single heating circuit (4), in which a first heating medium is circulated, and in that the single heating circuit (4) is directly or indirectly connected to the vaporizing unit (5;51;56).

2. Floating LNG storage and re-gasification unit according to claim 1, characterised in that the power plant (3) comprises an internal combustion engine, and in that the heat sources comprise an engine high temperature cooling water circuit (31), an engine low temperature cooling water circuit (32), a lubricating oil circuit (33), an engine jacket water circuit (34), and an exhaust gas heat exchanger (35).

3. Floating LNG storage and re-gasification unit according to claim 2, characterised in that the internal combustion engine is a gas engine or a dual fuel engine.

4. Floating LNG storage and re-gasification unit according to claim 1, characterised in that the single heating circuit (4) is directly connected to the vaporizing unit (5;51), and in that the single heating circuit is led from the power plant (3) directly to the vaporizing unit (5;51) and from the vaporizing unit (5;51) back to the power plant (3).

5. Floating LNG storage and re-gasification unit according to claim 4, characterised in that the single heating circuit (4) is provided with an auxiliary heat exchanger (6) arranged between the vaporizing unit (5;51) and the power plant (3), and in that a seawater circuit (61,62) is connected to the auxiliary heat exchanger (6).

6. Floating LNG storage and re-gasification unit according to claim 4, characterised in that the vaporizing unit (51) is a submerged combustion vaporizing unit, and in that the submerged combustion vaporizing unit is provided with a natural gas burner (54), a fuel feed line (52), an air supply line (53) and an exhaust gas discharge (55).

7. Floating LNG storage and re-gasification unit according to claim 1, characterised in that the single heating circuit (4) is indirectly connected to the vaporizing unit (56), and in that the single heating circuit is led from the power plant (3) directly to an auxiliary heat exchanger (6) which is directly connected to the vaporizing unit (56), and from the auxiliary heat exchanger (6) back to the power plant (3).

8. Floating LNG storage and re-gasification unit according to claim 7, characterised in that the vaporizing unit (56) is a open rack vaporizing unit, and in that a sea water circuit (61,62), in which sea water is circulated as a second heating medium, is connected to the auxiliary heat exchanger (6) and to the vaporizing unit (51).

9. Method of re-gasification of LNG on a floating LNG storage and re-gasification unit, in which method LNG is stored in a LNG storage tank (2), LNG is transferred from the storage tank to a vaporizing unit (5;51;56), and a power plant (3) on the floating LNG storage and re-gasification unit is operated for generating heat for the vaporizing unit, characterised in that heat generated in a number of heat sources of the power plant (3) is recovered, and in that the recovered heat is collected into a single heating circuit (4) and supplied through the single heating circuit directly or indirectly to the vaporizing unit (5;51;56) by means of a first heating medium circulated in the single heating circuit (4).

10. Method according to claim 9, characterised in that an internal combustion engine is employed as the power plant (3), that heat is recovered from a number of heat sources of the internal combustion engine, said heat sources comprising an engine high temperature cooling water circuit (31), an engine low temperature cooling water circuit (32), a lubricating oil circuit (33), an engine jacket water circuit (34), and an exhaust gas heat exchanger (35), and in that the recovered heat is collected into the single heating circuit (4).

11. Method according to claim 10, characterised in that the internal combustion engine is fuelled by gas or by dual fuel.

12. Method according to claim 9, characterised in that the recovered heat is directly supplied to the vaporizing unit (5;51) by means of the first heating medium for vaporizing LNG, and in that the first heating medium is circulated back to the power plant (3) from the vaporizing unit (5;51).

13. Method according to claim 12, characterised in that a submerged combustion vaporizing unit is employed as the vaporizing unit (51), that a natural gas burner (54) is employed as a main source of heat for the vaporizing unit (51), and in that the single heating circuit (4) is employed as a supplementary source of heat for the vaporizing unit (51).

14. Method according to claim 9, characterised in that recovered heat is directly supplied to an auxiliary heat exchanger (6), which is connected to the vaporizing unit (56), that the recovered heat is used to heat a second heating medium circulated through the auxiliary heat exchanger (6) and the vaporizing unit (56), and in that the first heating medium is circulated back to the power plant (3) from the auxiliary heat exchanger (6).

15. Method according to claim 14, characterised in that an open rack vaporizing unit is employed as the vaporizing unit (51), that the second heating medium is sea water circulated in a sea water circuit (61,62), which is employed as a main source of heat for the vaporizing unit (56), and in that the single heating circuit (4) is employed as a supplementary source of heat for the vaporizing unit (56).

16. Method according to claim 9, characterised in that the first heating medium circulated in the single heating circuit (4) is cooled by the second heating media in the sea water circuit (61,62) when the power plant (3) is operated and the vaporizing unit (5;51;56) is not employed.
